(19) United States
(12) Patent Application Publication
(10) Pub. No.: US 2026/0247204 A1
(43) Pub. Date: Aug. 20, 2026

(54) TECHNIQUES FOR CONGESTION CONTROL OF A SHARED RESOURCE POOL

(71) Applicant: QUALCOMM Incorporated, San Diego, CA (US)

(72) Inventors: Diana MAAMARI, San Diego, CA (US); Gabi SARKIS, San Diego, CA (US); Jing SUN, San Diego, CA (US); Prasada Veera Reddy KADIRI, San Diego, CA (US); Raviteja PATCHAVA, San Diego, CA (US); Mickael MONDET, Louannec (FR); Linhai HE, San Diego, CA (US)

(21) Appl. No.: 19/057,354

(22) Filed: Feb. 19, 2025

(51) Int. Cl. H04W 28/02; H04W 28/18

(52) U.S. Cl. CPC H04W 28/0231; H04W 28/0257; H04W 28/18

(57) ABSTRACT

Various aspects of the present disclosure generally relate to wireless communication. In some aspects, a user equipment (UE) may receive configuration information indicating at least one of a congestion threshold associated with a shared resource pool, or one or more backoff values associated with the shared resource pool. The UE may determine at least one of whether congestion information for the shared resource pool satisfies the congestion threshold, or a backoff value, of the one or more backoff values, associated with the congestion information. The UE may transmit, based at least in part on the determination of the at least one of whether the congestion information satisfies the congestion threshold, or the backoff value associated with the congestion information, a communication. Numerous other aspects are described.

### FIELD OF THE DISCLOSURE

Aspects of the present disclosure generally relate to wireless communication and specifically relate to techniques, apparatuses, and methods associated with congestion control of a shared resource pool.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some wireless communication systems, a user equipment (UE) may communicate with a network node using a shared resource pool, sometimes referred to as the UE performing connectionless uplink transmissions. In connectionless uplink transmissions, the network node may provision a shared resource pool for multiple UEs to be used for small uplink packet transmissions without explicit uplink grants from the network node. In such examples, uplink transmissions associated with the shared resource pool may be contention-based, may be associated with various payload sizes, or may be associated with various modulation and coding schemes (MCSs), among other examples. Additionally, or alternatively, the network node may receive the uplink transmissions using blind-decoding or the network node may configure the shared resource pool based on traffic needs, network-node processing capabilities, or similar considerations.

### SUMMARY

Some aspects described herein relate to a method of wireless communication performed by a user equipment (UE). The method may include receiving configuration information indicating at least one of a congestion threshold associated with a shared resource pool, or one or more backoff values associated with the shared resource pool. The method may include determining at least one of whether congestion information for the shared resource pool satisfies the congestion threshold, or a backoff value, of the one or more backoff values, associated with the congestion information. The method may include transmitting, based at least in part on the determination of the at least one of whether the congestion information satisfies the congestion threshold, or the backoff value associated with the congestion information, a communication.

Some aspects described herein relate to a method of wireless communication performed by a network node. The method may include transmitting, to a UE, configuration information indicating at least one of a congestion threshold associated with a shared resource pool, or one or more backoff values associated with the shared resource pool. The method may include receiving, from the UE, a communication, wherein at least one of, the communication is received using the shared resource pool based at least in part on congestion information associated with the shared resource pool not satisfying the congestion threshold, the communication is received using the shared resource pool and is associated with a backoff value, of the one or more backoff values, that is based at least in part on the congestion information, or the communication is received using resources outside of the shared resource pool based at least in part on the congestion information satisfying the congestion threshold.

Some aspects described herein relate to a UE. The UE may include a processing system. The processing system may include one or more processors and one or more code-storing memories coupled with the one or more processors. The processing system may be configured to cause the UE to receive configuration information indicating at least one of a congestion threshold associated with a shared resource pool, or one or more backoff values associated with the shared resource pool. The processing system may be configured to cause the UE to determine at least one of whether congestion information for the shared resource pool satisfies the congestion threshold, or a backoff value, of the one or more backoff values, associated with the congestion information. The processing system may be configured to cause the UE to transmit, based at least in part on the determination of the at least one of whether the congestion information satisfies the congestion threshold, or the backoff value associated with the congestion information, a communication.

Some aspects described herein relate to a network node. The network node may include a processing system. The processing system may include one or more processors and one or more code-storing memories coupled with the one or more processors. The processing system may be configured to cause the network node to transmit, to a UE, configuration information indicating at least one of a congestion threshold associated with a shared resource pool, or one or more backoff values associated with the shared resource pool. The processing system may be configured to cause the network node to receive, from the UE, a communication, wherein the processing system, to receive the communication, is configured to cause the network node to at least one of receive the communication using the shared resource pool based at least in part on congestion information associated with the shared resource pool not satisfying the congestion threshold, receive the communication using the shared resource pool, wherein the communication is associated with a backoff value, of the one or more backoff values, that is based at least in part on the congestion information, or receive the communication using resources outside of the shared resource pool based at least in part on the congestion information satisfying the congestion threshold.

Some aspects described herein relate to a non-transitory computer-readable medium that stores a set of instructions for wireless communication by a UE. The set of instructions, when executed by one or more processors of the UE, may cause the UE to receive configuration information indicating at least one of a congestion threshold associated with a shared resource pool, or one or more backoff values associated with the shared resource pool. The set of instructions, when executed by one or more processors of the UE, may cause the UE to determine at least one of whether congestion information for the shared resource pool satisfies the congestion threshold, or a backoff value, of the one or more backoff values, associated with the congestion information. The set of instructions, when executed by one or more processors of the UE, may cause the UE to transmit, based at least in part on the determination of the at least one of whether the congestion information satisfies the congestion threshold, or the backoff value associated with the congestion information, a communication.

Some aspects described herein relate to a non-transitory computer-readable medium that stores a set of instructions for wireless communication by a network node. The set of instructions, when executed by one or more processors of the network node, may cause the network node to transmit, to a UE, configuration information indicating at least one of a congestion threshold associated with a shared resource pool, or one or more backoff values associated with the shared resource pool. The set of instructions, when executed by one or more processors of the network node, may cause the network node to receive, from the UE, a communication, wherein the set of instructions, to receive the communication, may cause the network node to at least one of receive the communication using the shared resource pool based at least in part on congestion information associated with the shared resource pool not satisfying the congestion threshold, receive the communication using the shared resource pool, wherein the communication is associated with a backoff value, of the one or more backoff values, that is based at least in part on the congestion information, or receive the communication using resources outside of the shared resource pool based at least in part on the congestion information satisfying the congestion threshold.

Some aspects described herein relate to an apparatus for wireless communication. The apparatus may include means for receiving configuration information indicating at least one of a congestion threshold associated with a shared resource pool, or one or more backoff values associated with the shared resource pool. The apparatus may include means for determining at least one of whether congestion information for the shared resource pool satisfies the congestion threshold, or a backoff value, of the one or more backoff values, associated with the congestion information. The apparatus may include means for transmitting, based at least in part on the determination of the at least one of whether the congestion information satisfies the congestion threshold, or the backoff value associated with the congestion information, a communication.

Some aspects described herein relate to an apparatus for wireless communication. The apparatus may include means for transmitting, to a UE, configuration information indicating at least one of a congestion threshold associated with a shared resource pool, or one or more backoff values associated with the shared resource pool. The apparatus may include means for receiving, from the UE, a communication, wherein the means for receiving the communication include at least one of means for receiving the communication using the shared resource pool based at least in part on congestion information associated with the shared resource pool not satisfying the congestion threshold, means for receiving the communication using the shared resource pool, wherein the communication is associated with a backoff value, of the one or more backoff values, that is based at least in part on the congestion information, or means for receiving, from the UE, the communication using resources outside of the shared resource pool based at least in part on the congestion information satisfying the congestion threshold.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIGS. 3A-3C are diagrams illustrating examples associated with user equipments (UEs) transmitting uplink communications using a shared resource pool.

FIGS. 4A-4B are diagrams of examples associated with congestion control for a shared resource pool.

FIG. 5 is a diagram illustrating an example process performed, for example, at a UE or an apparatus of a UE.

FIG. 6 is a diagram illustrating an example process performed, for example, at a network node or an apparatus of a network node.

FIG. 7 is a diagram of an example apparatus for wireless communication.

FIG. 8 is a diagram of an example apparatus for wireless communication.

### DETAILED DESCRIPTION

In some examples, due to the large coverage area or narrow-band nature of some frequency division duplex (FDD) low-band carriers, among other examples, a network node may experience numerous user equipment (UEs) camping on a carrier. In such instances, the numerous UEs may be associated with relatively low duty-cycle traffic or may be associated with relatively small packets to the transmit in the uplink, such as when the UEs are associated with Internet of Things (IoT) UEs, among other examples. These numerous UEs camping on a carrier may result in relatively congested communication channels or relatively high resource consumption associated with overhead for supporting the numerous uplink transmissions. In some examples, to reduce overhead associated with the uplink transmissions or for a similar purpose, a network node may configure the UEs to use connectionless uplink, in which the network node provisions a shared resource pool for a set of UEs and the UEs self-schedule small uplink packet transmissions using the shared resource pool.

However, connectionless uplink transmissions may pose a risk of colliding uplink transmissions using the shared resource pool. In this regard, connectionless uplink transmissions may be implemented in sparsely-loaded cells in order to avoid collisions, among other examples. Nonetheless, during periods of high traffic or other periods of heavy loading at a cell, colliding uplink transmissions may occur in the shared resource pool, resulting in communication errors and thus high power, computing, and resource consumption for correcting communication errors.

Various aspects relate generally to congestion control of a shared resource pool. Some aspects more specifically relate to congestion control techniques by one or more UEs transmitting uplink communications using a shared resource pool. In some aspects, a network node may configure a UE with at least one of a congestion threshold associated with a shared resource pool, or one or more backoff values associated with the shared resource pool. Prior to transmitting a communication using the shared resource pool, the UE may determine if congestion information (e.g., information signaled to the UE by the network node or else determined at the UE using a congestion model, among other examples) for the shared resource pool satisfies the congestion threshold, or the UE may determine a backoff value associated with the congestion information. The UE may transmit a communication based at least in part on the determination of whether the congestion information satisfies the congestion threshold, or the determination of the backoff value associated with the congestion information. For example, in some aspects the UE may transmit the communication using the shared resource pool based at least in part on the congestion information not satisfying the congestion threshold. In some other aspects, the UE may transmit the communication using resources outside of the shared resource pool based at least in part on the congestion information satisfying the congestion threshold. And in still some other aspects, the UE may map the congestion information to a backoff value and transmit the communication using the shared resource pool and based at least in part on applying the backoff value.

Particular aspects of the subject matter described in this disclosure can be implemented to realize one or more of the following potential advantages. In some examples, the described techniques can be used to reduce uplink collisions in a shared resource pool, thus reducing communication errors associated with the shared resource pool and thus reducing power, computing, and network resource consumption otherwise required to identify and correct communication errors. In some other examples, the described techniques can be used to dynamically control whether or not a shared resource pool is to be used by the UEs, thereby reducing overhead (e.g., scheduling requests and dynamic grants) for some uplink communications when traffic or channel conditions permit use of the shared resource pool, thus reducing delay and uplink/downlink control overhead and thus increasing network speed and conserving computing resources (e.g., processing resources, memory resources, communication resources, or similar resources), networking resources, or power resources, among other examples.

5G New Radio (NR) may support enhanced mobile broadband (eMBB) access, IoT networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

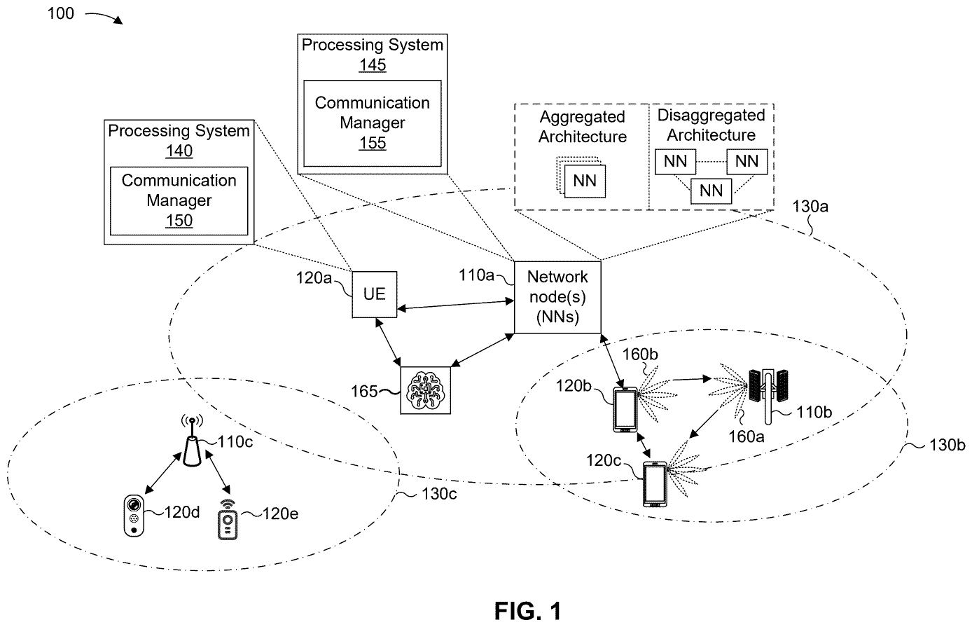

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a, a network node 110b, and a network node 110c (each of which also may be referred to herein simply as a “network node 110”). The network nodes 110 may support communications with multiple UEs 120. For example, in FIG. 1, the network nodes 110 support communication with a UE 120a, a UE 120b, a UE 120c, a UE 120d, and a UE 120e (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a, a cell 130b, and a cell 130c).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) number of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

Some UEs 120 may be considered machine-type communication (MTC) UEs, evolved or enhanced machine-type communication (eMTC) UEs, further enhanced eMTC (feMTC) UEs, enhanced feMTC (efeMTC) UEs, massive MTC (mMTC) UEs, ultra-reliable low-latency MTC (uMTC) UEs, or further evolutions thereof, all of which may be simply referred to as “MTC UEs.” For example, the UE 120e may be an MTC UE. MTC refers to wireless communication between devices or machines that are not directly operated by humans. An MTC UE may be, may include, or may be included in or coupled with a robot, an uncrewed aerial vehicle, a remote device, a sensor, a meter, a monitor, or a location tag, among other examples. MTC systems may enable autonomous communication between devices using low-power, low-latency, and high-reliability communication.

Some UEs 120 may be considered IoT devices. Some such UEs 120 may be implemented as NB-IoT (narrowband IoT) devices, such as the UE 120d. IoT communication may refer to wireless communication between devices or machines that may involve human interaction. An IoT or NB-IoT device may be, may include, or may be included in or coupled with an industrial machine, an appliance, a refrigerator, a doorbell camera device, a home automation device, or a light fixture, among other examples. IoT devices may be deployed in an ecosystem of interconnected devices for a range of applications involving both human and machine interactions.

Some UEs 120 may be considered Customer Premises Equipment (CPEs), which may include telecommunications devices that are installed at a customer location (such as a home or office) to enable access to a service provider's network (such as included in or in communication with the wireless communication network 100). CPEs may enable devices within an area (e.g., a home, a business, a factory, or a premises) to connect with the wireless communication network 100. A CPE may include a modem, a router, a gateway, an access point, or a smart home device that enables connection to the wireless communication network 100.

MTC, IoT, or CPE technologies may enable use cases, such as autonomous system and robotics (e.g., industrial IoT, industrial automation, or autonomous vehicles), massive IoT systems, wearable health and medical devices, environment monitoring, smart grids or energy management, XR systems, public safety and emergency response systems (e.g., enabling the deployment of connected MTC UEs, such as unmanned ariel vehicles, wearable sensors, or emergency communication systems), among other examples. MTC UEs may leverage mMTC, URLLC, edge computing, artificial intelligence or machine learning, network slicing, low-power systems (e.g., low-power radios or low-power wide area networks), or new spectrum bands (e.g., terahertz spectrum bands), among other examples, to enable connected deployments of MTC UEs within the wireless communication network 100.

In some aspects, the UE 120 may include a communication manager 150. As described in more detail elsewhere herein, the communication manager 150 may receive configuration information indicating at least one of a congestion threshold associated with a shared resource pool or one or more backoff values associated with the shared resource pool; determine at least one of whether congestion information for the shared resource pool satisfies the congestion threshold or a backoff value, of the one or more backoff values, associated with the congestion information; and transmit, based at least in part on the determination of the at least one of whether the congestion information satisfies the congestion threshold or the backoff value associated with the congestion information, a communication. Additionally, or alternatively, the communication manager 150 may perform one or more other operations described herein.

In some aspects, the network node 110 may include a communication manager 155. As described in more detail elsewhere herein, the communication manager 155 may transmit, to a UE, configuration information indicating at least one of a congestion threshold associated with a shared resource pool or one or more backoff values associated with the shared resource pool; and receive, from the UE, a communication, wherein at least one of: the communication is received using the shared resource pool based at least in part on congestion information associated with the shared resource pool not satisfying the congestion threshold, the communication is received using the shared resource pool and is associated with a backoff value, of the one or more backoff values, that is based at least in part on the congestion information, or the communication is received using resources outside of the shared resource pool based at least in part on the congestion information satisfying the congestion threshold. Additionally, or alternatively, the communication manager 155 may perform one or more other operations described herein.

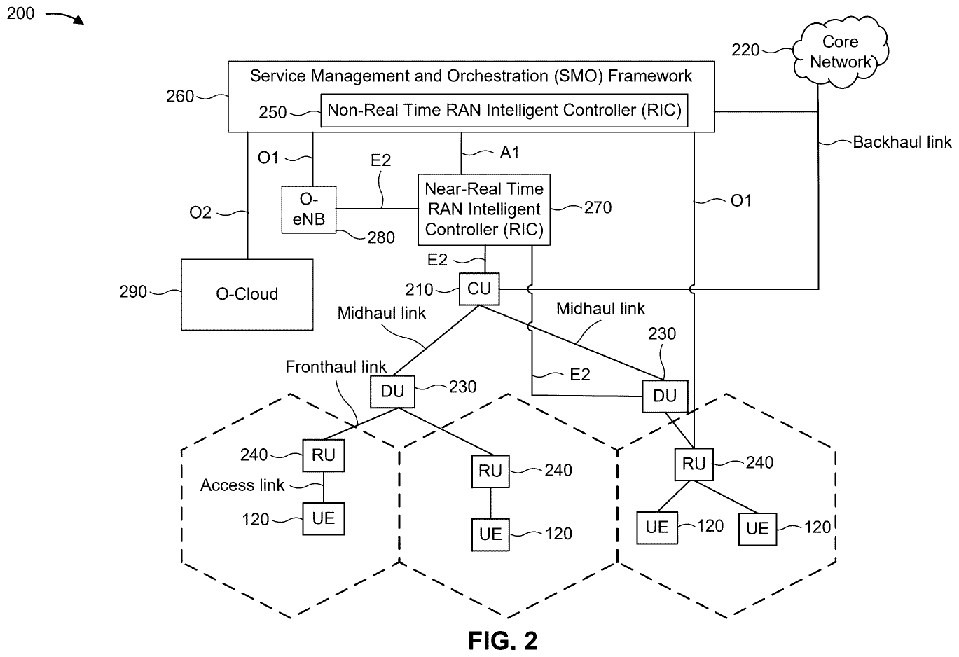

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the

SMO Framework 260 (such as reconfiguration via an O1 interface) or via creation of RAN management policies (such as A1 interface policies).

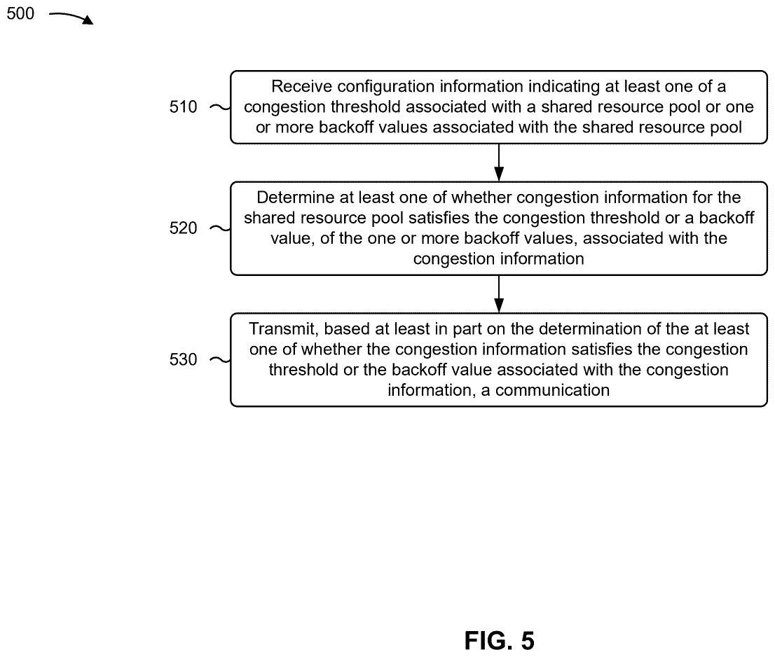

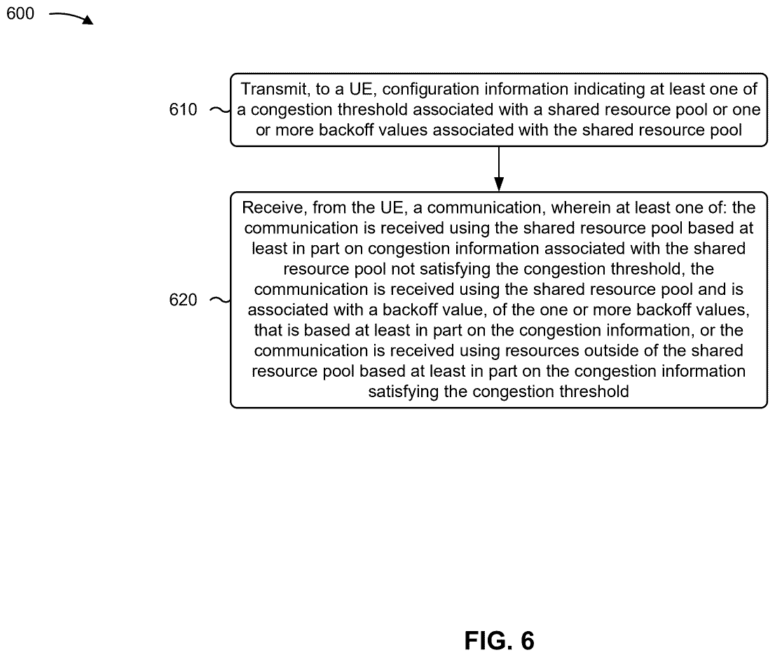

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with congestion control of a shared resource pool, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, or other processes as described herein. In some examples, executing instructions may include running the instructions, converting the instructions, compiling the instructions, or interpreting the instructions, among other examples.

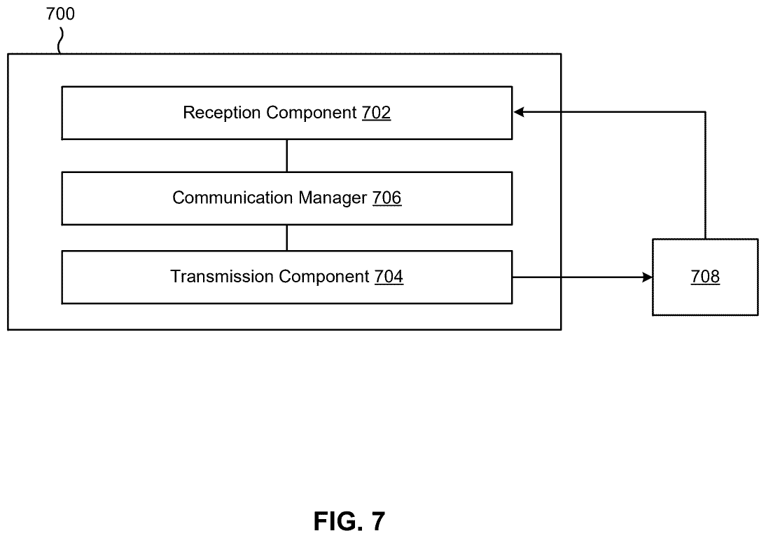

In some aspects, the UE 120 includes means for receiving configuration information indicating at least one of a congestion threshold associated with a shared resource pool, or one or more backoff values associated with the shared resource pool; means for determining at least one of whether congestion information for the shared resource pool satisfies the congestion threshold, or a backoff value, of the one or more backoff values, associated with the congestion information; or means for transmitting, based at least in part on the determination of the at least one of whether the congestion information satisfies the congestion threshold, or the backoff value associated with the congestion information, a communication. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

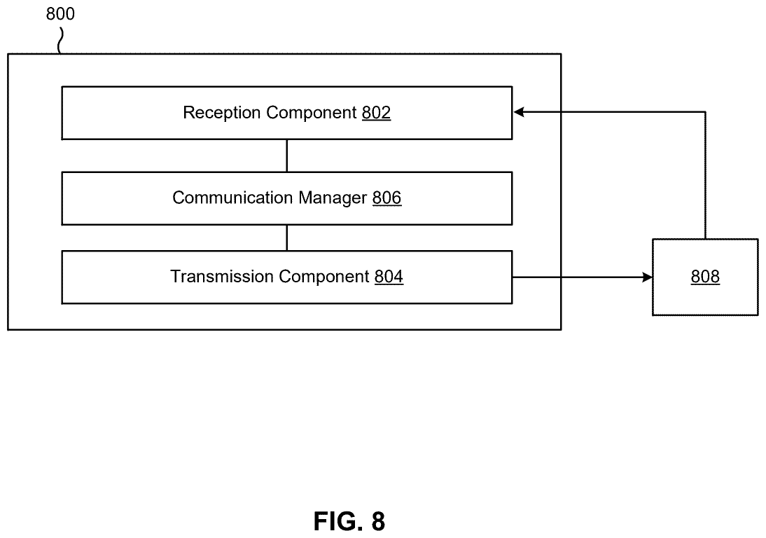

In some aspects, the network node 110 includes means for transmitting, to a UE, configuration information indicating at least one of a congestion threshold associated with a shared resource pool, or one or more backoff values associated with the shared resource pool; or means for receiving, from the UE, a communication, wherein at least one of: the communication is received using the shared resource pool based at least in part on congestion information associated with the shared resource pool not satisfying the congestion threshold, the communication is received using the shared resource pool and is associated with a backoff value, of the one or more backoff values, that is based at least in part on the congestion information, or the communication is received using resources outside of the shared resource pool based at least in part on the congestion information satisfying the congestion threshold. The means for the network node 110 to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

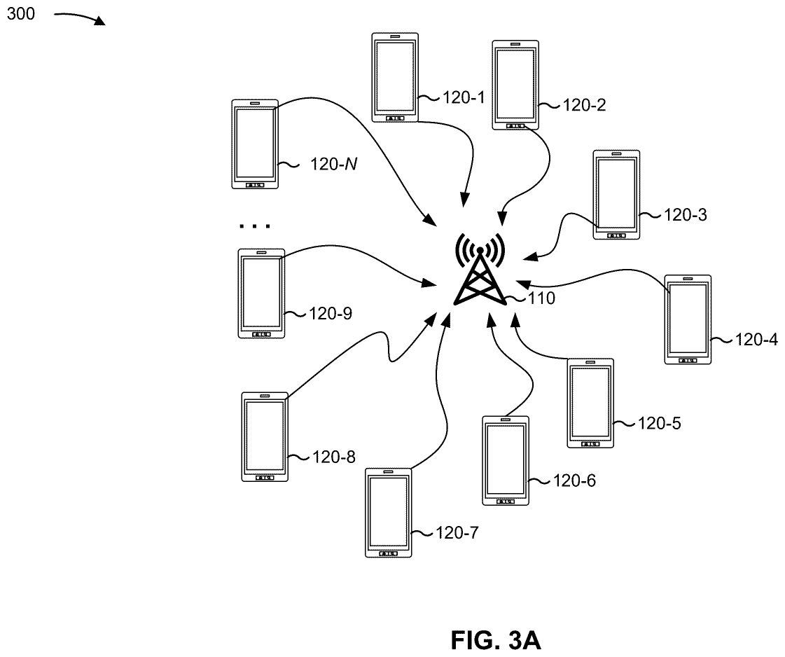

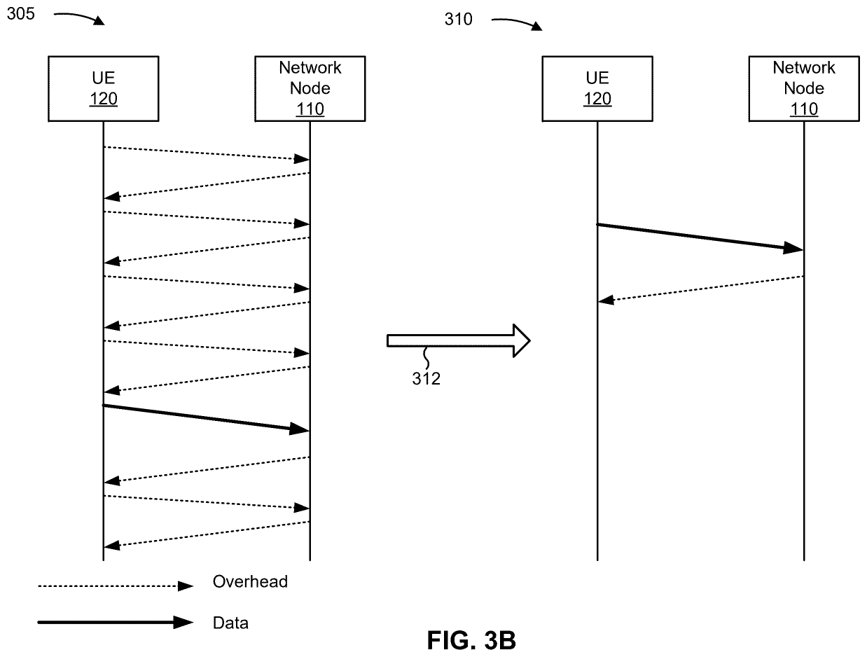

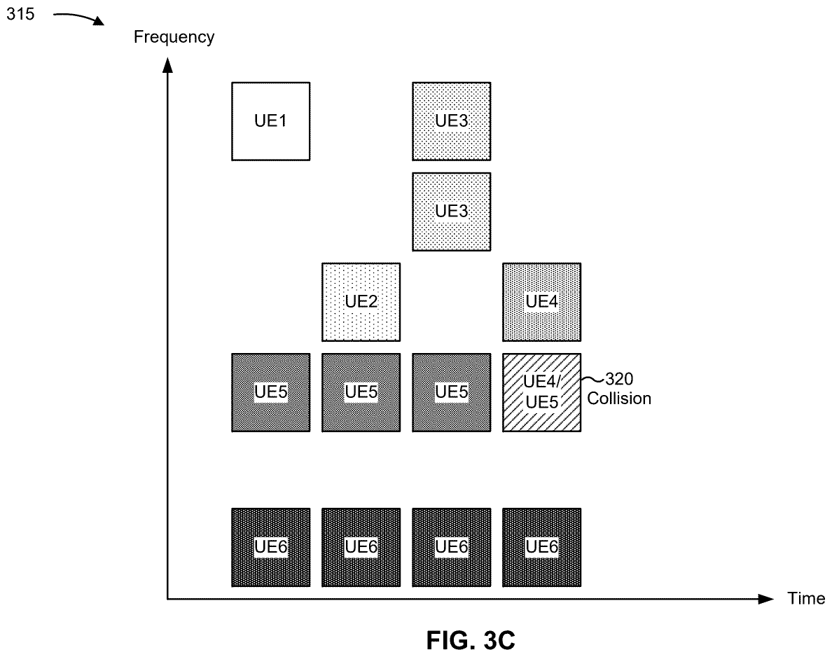

FIGS. 3A-3C are diagrams illustrating examples associated with UEs transmitting uplink communications using a shared resource pool.

As shown in FIG. 3A, and by example 300, due to the large coverage area or narrow-band nature of some FDD low-band carriers, among other examples, a network node 110 may experience numerous UEs 120 camping on a carrier. For example, as shown in example 300, a first UE 120-1 through an N^{th} UE 120-N, which may be MBB UEs or IoT UEs, among other examples, may camp on a carrier. In some examples, the numerous UEs 120 may be either in RRC connected or RRC idle mode, may be associated with relatively low duty-cycle traffic, or may be associated with relatively small packets to the transmit in the uplink (such as when the UEs 120 are associated with IoT UEs, among other examples).

In some examples, the numerous UEs 120 camping on a carrier may result in relatively congested communication channels or relatively high overhead for supporting the numerous uplink transmissions. For example, as shown in FIG. 3B, and by the example communications indicated by reference number 305, a data transmission from a UE 120 to a network node 110 (shown in FIG. 3B using a bold, solid arrow) may be associated with multiple overhead transmissions (shown in FIG. 3 using broken-line arrows). These overhead transmissions may be associated with PRACH transmissions, SR transmissions, buffer status report (BSR) transmissions, UL grant transmissions, CSI-RS transmissions, feedback transmissions (e.g., HARQ ACK/NACK transmissions), or similar transmissions.

Accordingly, in some examples, techniques may be utilized to reduce overhead associated with some UEs 120 or UL transmissions, resulting in the fewer transmissions shown in connection with reference number 310. Put another way, techniques may be used to move from the numerous overhead transmissions indicated by reference number 305 to the relatively few overhead transmissions as indicated by reference number 310, which is schematically depicted in FIG. 3B using arrow 312. For example, some techniques may be used to reduced overhead transmissions in instances in which multiple UEs 120 camped on a carrier tend to transmit small or frequent uplink packets to the network node 110.

In some examples, connectionless UL transmissions (sometimes referred to herein as transmissions associated with UE-based scheduling) using a shared resource pool may be used to reduce overhead associated with frequent uplink transmissions. More particularly, as shown in FIG. 3C, a network node 110 may provision a shared resource pool 315 for multiple UEs 120 (e.g., the first UE 120-1 through the N^{th} UE 120-N described above in connection with FIG. 3A) to be used for small UL packet transmissions without explicit UL grants from the network node 110 to the UEs 120. In such examples, UL transmissions using the shared resource pool 315 may be contention-based, may be associated with various payload sizes (e.g., a payload size to be transmitted using the shared resource pool 315 may not be fixed in order to accommodate different applications, among other examples), or may be associated with various MCSs (e.g., the shared resource pool 315 may accommodate near-far users, among other examples). In some examples, such as examples associated with relatively large cells, the various UEs 120 may acquire timing before using the shared resource pool 315. Moreover, in some examples, the network node 110 may perform blind-decoding for the shared-resource-pool-based transmissions or may configure the shared resource pool 315 based at least in part on traffic needs, network-node processing capabilities, or similar considerations. Additionally, or alternatively, in order to ensure reliable delivery of packets using the shared resource pool 315, connectionless UL transmissions using the shared resource pool 315 may be associated with reception acknowledgment or retransmission mechanisms.

In some examples, connectionless UL transmissions using the shared resource pool 315 may pose a risk of colliding UL transmissions. More particularly, in the example shown in FIG. 3C, multiple UEs 120 may use the shared resource pool 315 for transmitting UL transmissions. For example, a first UE 120 may transmit a first set of one or more UL packets in the shared resource pool 315 (shown using a box labeled “UE1” in FIG. 3C), a second UE 120 may transmit a second set of one or more UL packets in the shared resource pool 315 (shown using a box labeled “UE2” in FIG. 3C), and so forth through a sixth UE 120 transmitting a sixth set of one or more UL packets in the shared resource pool 315 (shown using boxes labeled “UE6” in FIG. 3C). As indicated by reference number 320, and as showing using hatching, in this example a fourth UE 120 and a fifth UE 120 may attempt to use a same subset of the shared resource pool 315 for transmitting an UL packet, resulting in an UL collision.

In this regard, connectionless UL transmissions (e.g., UE-based scheduling) may sometimes be limited to sparsely-loaded cells in order to avoid collisions, such as the collision described above in connection with reference number 320, among other examples. Additionally, or alternatively, in some examples a network node 110 may apply dynamic admission-control techniques to limit UE 120 usage of the shared resource pool 315 during heavy traffic periods. For example, the network node 110 may delay access to the shared resource pool 315 using a random-number-based backoff value to flatten out access to the shared resource pool 315, among other examples. Additionally, or alternatively, the network node 110 may dynamically add additional resource pools during the periods of heavy traffic or else increase a size of shared resource pool 315 during periods of heavy traffic. In some examples, a network node 110 may allocate a heterogeneous resource pool for connectionless UL transmissions, such as for purposes of supporting mixed resources for different MCSs, different allocation sizes, or other differing parameters over partially overlapping resources. For example, the network node 110 may allocate different time-frequency resources of a shared resource pool with different MCSs, among other examples.

Additionally, or alternatively, in some examples a UE backoff mechanism may be employed in connectionless UL transmissions to reduce UL collisions. As used herein, “backoff” refers to a reduction (e.g., scaling) of a bit rate used for an UL transmission or a similar transmission parameter, such as for a purpose of reducing a transmission size or an amount of UL resources needed for the transmission. For example, a network node 110 may indicate (e.g., using a configured grant PDCCH (CG-PDCCH), among other examples) that the multiple UEs 120 are to apply a backoff value that is based on MCS, such that if the network node 110 detects congestion associated with an MCS, the network node 110 may increase the backoff range for the corresponding UEs (e.g., the UEs using the MCS) to avoid UL collisions. Similarly, a network node 110 may indicate that the multiple UEs 120 are to apply a backoff value that is based on allocation size, such that UEs 120 associated with larger allocation sizes may use smaller backoff values because there may be a lower chance of collision. Additionally, or alternatively, a network node 110 may indicate that the multiple UEs 120 are to apply a backoff value that is based on payload size, such as by allocating a higher backoff value for UEs 120 with a higher payload thus enabling UEs 120 with a lower payload to transmit first followed by UEs 120 with a higher payload. In such instances, the network node 110 may also restrict the UEs 120 to a given amount of data to be transmitted in each resource pool occasion.

Moreover, in some examples a network node 110 may indicate that the multiple UEs 120 are to apply a backoff value that is based on a number of layers in an MU-MIMO transmission. In such examples, UEs 120 transmitting in a high number of layers may have a higher backoff value compared to UEs 120 transmitting with a low number of layers. Additionally, or alternatively, the network node 110 may restrict the UEs 120 to transmit with a maximum number of layers. Additionally, or alternatively, in some examples a network node 110 may indicate that the multiple UEs 120 are to apply a backoff value that is based on a combination of MCS, a number of layers, an allocation size, or a payload size, among other factors. Nonetheless, during periods of high traffic, the shared resource pool may still be associated with colliding UL transmissions, leading to communication errors and thus high power, computing, and resource consumption for correcting communication errors, or else causing the UEs 120 and the network node to forgo use of connectionless UL transmissions altogether, resulting in high overhead, crowded communication channels, and otherwise inefficient usage of network resources.

Some aspects and techniques described herein enable a UE 120 to map congestion information to use of a shared resource pool (e.g., shared resource pool 315) or to a backoff value to be used when transmitting in the shared resource pool. For example, in some aspects a UE 120 may receive, from a network node 110, a congestion indication associated with a congestion level of a shared resource pool, while, in some other aspects, a UE 120 may autonomously determine a congestion level associated with the shared resource pool (such as by using an AI/ML model at the UE 120, among other examples). In such aspects, the UE 120 may determine whether the congestion information satisfies a congestion threshold, or else may map the congestion information to a backoff value. The UE 120 may transmit an UL communication based at least in part on the determination of whether the congestion information satisfies a congestion threshold, or based at least in part on the determination of the backoff value. For example, in aspects in which the congestion information does not satisfy the threshold (indicative of low congestion or a low probability of UL collisions), the UE 120 may transmit the communication using the shared resource pool. However, in aspects in which the congestion information satisfies the congestion threshold (indicative of high congestion or a high probability of UL collisions), the UE 120 transmit the communication outside of the shared resource pool, such as by transmitting a resource request message (e.g., an SR, among other examples) and transmitting the communication using resources indicated by an UL grant message received in response to the resource request, among other examples. Additionally, or alternatively, the UE 120 may map congestion information to a backoff value when using the shared resource pool. For example, in aspects in which the congestion information indicates high congestion in shared resource pool, the UE 120 may use a relatively high backoff value, thereby significantly reducing a bit rate or other transmission parameter in order to reduce a probability of collision. On the other hand, in aspects in which the congestion information indicates low congestion in shared resource pool, the UE 120 may use a relatively low backoff value or no backoff value (e.g., a backoff value of zero), because the low congestion may pose a relatively low risk of UL collisions.

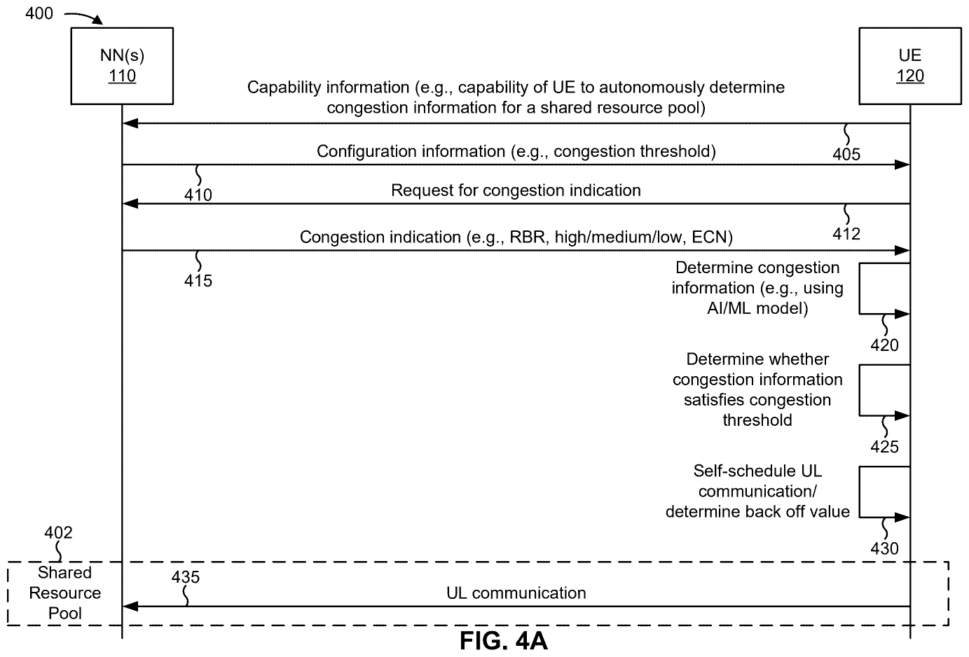

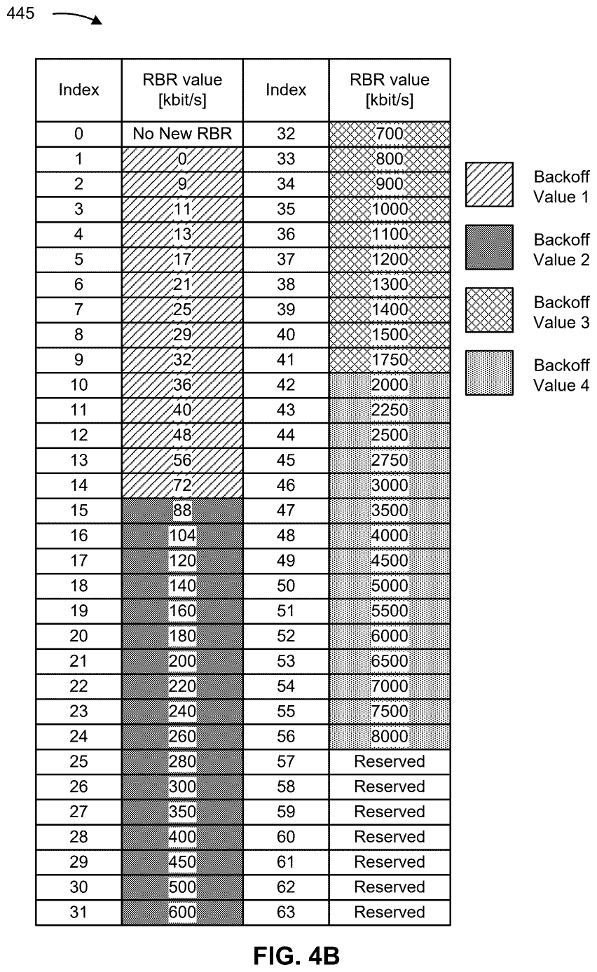

In this way, a shared resource pool may be effectively utilized for uplink transmissions, thereby enabling connectionless UL transmissions or UE self-scheduled transmissions and thus reducing overhead associated with frequent or small UL transmissions, increasing bandwidth, reducing latency, and otherwise resulting in more efficient use of network resources. Additionally, or alternatively, risk of UL collisions using the shared resource pool may be reduced, thereby reducing communication errors associated with the shared resource pool and thus reducing power, computing, and network resource consumption otherwise required to identify and correct communication errors. Aspects associated with a UE 120 performing congestion control for a shared resource pool in this manner as described in more detail below in connection with FIGS. 4A-4B.

As indicated above, FIGS. 3A-3C are provided as examples. Other examples may differ from what is described with respect to FIGS. 3A-3C.

FIGS. 4A-4B are diagrams of examples associated with congestion control for a shared resource pool. As shown in FIG. 4A, and by example 400, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 4A. In some aspects, the UE 120 may be one of multiple UEs 120 (e.g., the first UE 120-1 through the N^{th} UE 120-N described above in connection with FIG. 3A) configured to use a shared resource pool for UL communications, such as a shared resource pool 402 (which may be substantially similar to the shared resource pool 315 described above in connection with FIG. 3C). Additionally, or alternatively, the network node 110 may be capable of receiving UL communications from multiples UEs 120 (e.g., the first UE 120-1 through the N^{th} UE 120-N described above in connection with FIG. 3A) using the shared resource pool 402, such as by blind-decoding communications associated with the shared resource pool 402, among other examples.

In some aspects, as shown by reference number 405, the UE 120 may transmit, and the network node 110 may receive, capability information. The capability information may be included in a capability report. The UE 120 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a physical sidelink control channel (PSCCH), or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. For example, the capability information may indicate a capability or parameter for transmitting UL communications using a shared resource pool (e.g., for performing connectionless UL communications or UE-based scheduling communications). As another example, the capability information may indicate a capability or parameter for performing congestion control when transmitting UL communications using the shared resource pool, such as by mapping congestion information to a backoff value or comparing congestion information to a congestion threshold associated with the shared resource pool 402, which is described in more detail below. One or more operations described herein may be based on capability information. For example, the UE 120 may perform a communication in accordance with the capability information, or may receive configuration information that is in accordance with the capability information.

In some aspects, the capability information may indicate UE support for autonomously determining congestion information for the shared resource pool 402. For example, in some aspects the UE 120 may be capable of determining congestion information using a congestion model at the UE 120, such as an AI/ML model, among other examples (which is described in more detail below in connection with reference number 420). In such aspects, the capability information may indicate UE support for determining the congestion information using the congestion model (e.g., the AI/ML model).

As shown by reference number 410, the network node 110 may transmit, and the UE 120 may receive, configuration information. In some aspects, the UE 120 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples. Additionally, or alternatively, in aspects in which the UE 120 is in an RRC idle or inactive mode, the configuration information may be signaled via an RRC release message, among other examples. In some other aspects, the network node 110 may signal the configuration information using a SIB1. For example, using a UE access category associated with a SIB1, an access control associated with SIB1, or barring information associated with SIB1, among other examples, the network node 110 may indicate congestion information (e.g., a congestion metric such as high, medium, low, or a congestion percentage, among other examples) associated with the shared resource pool 402, a congestion threshold associated with the shared resource pool 402, different barring times for different UEs based on loading or congestion in the shared resource pool 402, backoff values associated with the shared resource pool 402, or similar information (e.g., the information described in more detail below in connection with the congestion indication shown in connection with reference number 415).

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC-CEs or one or more DCI messages, among other examples.

In some aspects, the configuration information may include an indication of a selection of one or more configuration parameters (e.g., a selection of the one or more configuration parameters already known to the UE 120 or previously indicated by the network node or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate a congestion threshold associated with the shared resource pool 402. For example, in some aspects the congestion threshold may be associated with a bit rate associated with the shared resource pool 402, such as a threshold that is associated with a recommended bit rate (RBR) to be signaled by the network node 110 to the UE 120 (described in more detail below in connection with reference number 415). More particularly, in some aspects the network node 110 may implicitly indicate congestion in a channel (e.g., a logical channel) by transmitting, to the UE 120, an RBR MAC-CE. The RBR MAC-CE may be used to provide a MAC entity at the UE 120 with a recommendation on what bit rate should be used by the UE 120 in the uplink. Put another way, the RBR MAC-CE may be used to indicate a RBR for the PHY layer during UL transmissions, among other information (e.g., in some aspects, the RBR MAC-CE may additionally, or alternatively, signal an RBR for DL transmissions). In some aspects, the RBR may be associated with an averaging window having a default value (which, in some aspects, may be 2000 milliseconds (ms)) or the RBR may be signaled per logical channel. As described in more detail below in connection with FIG. 4B, in some aspects the RBR may be signaled to the UE 120 by using an index or codepoint (e.g., one of 0 through 63) that corresponds to a selected RBR, of multiple candidate RBRs. In some aspects, an RBR may be used as a means to signal congestion in a channel, such as by signaling a high RBR to indicate low congestion level or by signaling a low RBR to indicate a high congestion level. In such aspects, the configuration information may indicate a bit rate as the congestion threshold.

In some other aspects, the congestion threshold may be associated with an explicit congestion level associated with the shared resource pool 402, such as a threshold that is associated with an explicit congestion indication to be signaled by the network node 110 to the UE 120 (described in more detail below in connection with reference number 415). More particularly, in some aspects the network node 110 may signal congestion in the shared resource pool 402 using a congestion-specific MAC-CE, among other examples. The congestion-specific MAC-CE may be used to provide the UE 120 with an indication of a congestion value associated with the shared resource pool 402. In some aspects, the congestion value may indicate one of high congestion, medium congestion, or low congestion, such as in aspects in which two bits are used to signal the congestion value. In some other aspects, the congestion value may be associated with a congestion percentage, in which a percentage (e.g., a value ranging from 0 to 100) is signaled to the UE 120 to indicate congestion in the shared resource pool 402, where a low percentage may correspond to a low congestion level and a high percentage level may correspond to a high congestion level. In such aspects, the configuration information may indicate a congestion percentage as the congestion threshold, a congestion value as the congestion threshold (e.g., one of high, medium, or low), or similar congestion information as the congestion threshold.

In some other aspects, the congestion threshold may be associated with a number of explicit congestion notification (ECN)-marked packets per time period associated with the shared resource pool 402, such as in aspects in which congestion information is conveyed to the UE 120 through ECN marking (described in more detail below in connection with reference number 415). More particularly, in some aspects the network node 110 (e.g., a RAN entity) or similar network entity (e.g., a user plane function (UPF) entity, among other examples) may perform ECN marking on packets (e.g., Internet protocol (IP) packets) as congestion in the shared resource pool 402 is detected by the network entity. In such aspects, an application server (sometimes referred to herein as a server end point) may receive the ECN-marked packets or may notify a client in the UE 120 of a level of congestion in the shared resource pool 402, such as by measuring the number of packets that are ECN-marked. For example, the server end point receiving the ECN-marked packets may inform the UE 120 of the congestion in the shared resource pool 402 or may indicate to the UE 120 that a bit rate should be reduced, among other examples. In such aspects, the congestion threshold may indicate a number of ECN-marked packets per time period associated with the shared resource pool 402 (e.g., the congestion threshold may be associated with a percentage of ECN-marked packets for a given time window), among other examples.

Additionally, or alternatively, in some aspects the configuration information may indicate multiple congestion thresholds. For example, the configuration information may indicate congestion thresholds on a logical-channel basis, with the congestion thresholds differing between logical channels, among other examples. Put another way, in some aspects the shared resource pool 402 may be associated with multiple logical channels, and the configuration information may a first congestion threshold that is associated with a first logical channel, of the multiple logical channels, a second (e.g., different) congestion threshold that is associated with a second logical channel, of the multiple logical channels, and so forth.

Additionally, or alternatively, the configuration information may indicate one or more backoff values associated with the shared resource pool 402. For example, as described in more detail below in connection with FIG. 4B, in some aspects the UE 120 may map congestion information (e.g., an RBR, a number of ECN-marked packets, an explicit congestion value, a congestion percentage, or similar congestion information) to a corresponding backoff value. In such aspects, the configuration information may indicate the candidate backoff values or may indicate corresponding congestion levels associated with each backoff value. For example, the configuration information may indicate that a first backoff value corresponds to a first range of RBRs, a first range of ECN-marking percentages, a first range of congestion percentages, or a first set of one or more congestion level values (e.g., a set of one or more of high, medium, or low), that a second backoff value corresponds to a second range of RBRs, a second range of ECN-marking percentages, a second range of congestion percentages, or a second set of one or more congestion level (e.g., a different set of one or more of high, medium, or low), and so forth.

The UE 120 may configure itself based at least in part on the configuration information. In some aspects, the UE 120 may be configured to perform one or more operations described herein based at least in part on the configuration information.

As described in more detail below in connection with reference numbers 415 in some aspects congestion information associated with the shared resource pool 402 (e.g., implicit or explicit congestion levels of the shared resource pool 402 to be compared to the configured congestion thresholds or mapped to the configured backoff values, as described above) may be signaled to the UE 120 by the network node 110 via a congestion indication (e.g., an RBR MAC-CE, a congestion-specific MAC-CE, or an indication of a number or percentage of ECN-marked packets, among other examples). In such aspects, the UE 120 may request that the congestion indication be transmitted, and the network node 110 may thus transmit the congestion indication (e.g., an initial congestion indication or, if a congestion indication has been previously transmitted to the UE 120, an updated congestion indication) to the UE 120 based at least in part on receiving the request to transmit the congestion indication.

More particularly, as indicated by reference number 412, the UE 120 may transmit, and the network node 110 may receive, a request for the congestion indication. For example, in some aspects, the UE 120 may receive (e.g., at a MAC layer of the UE 120, among other examples) data to be transmitted using the shared resource pool 402, and thus the UE 120 may transmit (e.g., using an UL MAC-CE, among other examples) the request for congestion indication (e.g., an indication that indicates a current congestion level associated with the shared resource pool 402). Put another way, in some aspects an arrival of new data to a logical channel that can make use of the shared resource pool 402 may trigger the UE 120 to query the network node 110 for the congestion indication. Additionally, or alternatively, the UE 120 may request the congestion indication by transmitting a request (e.g., an UL MAC-CE) for the congestion indication based at least in part on UE observed UL performance metrics, such as a number of retransmissions associated with the shared resource pool 402, UL transmit power used for the shared resource pool 402, or similar UL performance metrics associated with the shared resource pool 402. In some aspects, the UE 120 may transmit the request for the congestion indication based at least in part on configured thresholds (e.g., one or more performance-metric thresholds indicated by the configuration information described above in connection with reference number 410, among other examples).

As indicated by reference number 415, the network node 110 may transmit, and the UE 120 may receive, a congestion indication indicating the congestion information associated with the shared resource pool 402. As described above in connection with reference number 412, in some aspects the network node 110 may transmit the congestion indication in response to a request from the UE 120. Additionally, or alternatively, as described above in connection with reference number 410, in some aspects the congestion information may be implicit congestion information, such as an RBR per logical channel, among other examples. In such aspects, the congestion indication may be an RBR MAC-CE or similar communication indicating the one or more RBRs. In some other aspects, the congestion indication may be a MAC-CE (e.g., the congestion-specific MAC-CE described above in connection with reference number 410) that indicates an explicit congestion level associated with the shared resource pool (e.g., one of high, medium, or low, or a congestion percentage associated with the shared resource pool 402, among other examples). In still some other examples, the congestion information may be associated with ECN-marked packets associated with the shared resource pool. In such aspects, the congestion indication may originate from a server end point (e.g., an application server) directed to a client at the UE 120, and the congestion indication may indicate a percentage of ECN-marked packets (e.g., IP packets), among other examples. In that regard, in some aspects the congestion indication may be received via access stratum (AS) signaling (such as when the congestion indication is associated with an RBR MAC-CE or a congestion-specific MAC-CE, among other examples) or IP layer marking (such as when the congestion indication is associated with ECN-marked packets, among other examples). Moreover, although for ease of description the congestion indication is shown as originating from the network node 110, in some other aspects the UE 120 may receive the congestion indication from a different entity, such as from an application server over the Internet (e.g., using a WiFi capability of the UE 120), among other examples.

As described above in connection with reference number 405, in some aspects the UE 120 may be capable of autonomously determining the congestion information, such as by using an AI/ML model at the UE 120 or a similar congestion model at the UE 120. In such aspects, as indicated by reference number 420, the UE 120 may determine the congestion information, such as by determining the congestion information based at least in part on data associated with the shared resource pool 402. For example, the congestion model may estimate congestion in the shared resource pool 402 or a channel associated with the shared resource pool 402 based at least in part on TB size, time of arrival for TBs for a same frame, or similar information associated with the shared resource pool 402. Additionally, or alternatively, in some aspects determining the congestion information at the UE 120 may be based at least in part on a congestion model associated with the UE 120 satisfying one or more key performance indicator (KPI) checks. In this regard, in aspects in which the UE 120 indicates the capability to estimate the congestion (e.g., via the capability information described above in connection with reference number 405) or in which the congestion model passes the one or more KPI check (e.g., indicating that the congestion model is performing well), the UE 120 (e.g., a MAC layer of the UE 120) may, for each logical channel in an allowed list of logical channels for a shared-resource-pool-based transmission, estimate a corresponding congestion level, among other examples.

As indicated by reference number 425, the UE 120 may determine whether congestion information for the shared resource pool 402 satisfies a corresponding congestion threshold. For example, in aspects in which the congestion information is an RBR signaled to the UE 120 by the network node 110 and the congestion threshold is a configured bit rate, the UE 120 may determine whether the RBR exceeds the configured bit rate. Similarly, in aspects in which the congestion information is an explicit congestion level (e.g., high, medium, low, or a congestion percentage, among other examples) signaled to the UE 120 by the network node 110 and the congestion threshold is a configured congestion level (e.g., a selected one of high, medium, or low, or a specific congestion percentage), the UE 120 may determine whether the explicit congestion value satisfies the configured congestion level. Similarly, in aspects in which the congestion information is associated with ECN-marked packets signaled to a client at the UE 120 by a server end point, among other examples, the UE 120 may determine whether the number of ECN-marked packets or percentage of ECN-marked packets satisfies the configured ECN-marked packets value, among other examples.

As indicated by reference numbers 430 and 435, the UE 120 may self-schedule and transmit an UL communication using the shared resource pool 402, may determine a backoff value for the UL communication and transmission the UL communication using the shared resource pool 402 and the determined backoff value, or may transmit the UL communication using resources outside of the shared resource pool, among other examples. For example, in aspects involving the congestion threshold, if the UE 120 determines that the congestion information does not satisfy the congestion threshold (indicative that the congestion level in the shared resource pool 402 or a channel of the shared resource pool 402 is relatively low and thus there is little risk of UL collisions), the UE 120 may transmit the UL communication using resources in the shared resource pool 402, as indicated by reference number 435. Moreover, returning to the example in which the UE 120 indicates the capability to estimate the congestion (e.g., via the capability information described above in connection with reference number 405) or in which the congestion model passes one or more KPI checks (e.g., indicating that the congestion model is performing well), in the operations shown in connection with reference number 430, the UE 120 (e.g., a MAC layer of the UE 120) may, for each logical channel in an allowed list of logical channels for a shared-resource-pool-based transmission, determine whether the congestion information is below the configurable threshold and, if so, transmit the UL communication using the shared resource pool 402.

In some other aspects, if the UE 120 determines that the congestion information satisfies the congestion threshold (indicative that the congestion level in the shared resource pool 402 or a channel of the shared resource pool 402 is relatively high and thus there is increased risk of UL collisions), the UE 120 may transmit the UL communication using resources outside of the shared resource pool 402. In such aspects, the UE 120 may transmit a resource request (e.g., an SR, a BSR, or a similar resource request, not shown in FIG. 4A) associated with the UL communication based at least in part on the congestion information satisfying the congestion threshold, or may use any resources indicated by an UL grant message from the network node 110 for transmitting the UL communication.

In some other aspects, the UE 120 may map the congestion information to a backoff value to be used for the UL communication. For example, the UE 120 may determine a backoff value associated with the communication based at least in part on the congestion information, such as by mapping the congestion information to a selected backoff value, of multiple candidate backoff values (e.g., the multiple candidate backoff values signaled to the UE 120 via the configuration information, as described above in connection with reference number 410). In such aspects, the UE 120 may transmit the UL communication using the shared resource pool 402, but may do so by reducing a bit rate associated with the communication based at least in part on the determined backoff value (e.g., the UE 120 may transmit the UL communication by scaling back the bit rate based at least in part on the determined backoff value), among other examples.

More particularly, FIG. 4B shows an example 445 associated with mapping a backoff value to an RBR, as one example of the UE 120 determining a backoff value for a shared-resource-pool-based transmission. As shown in example 445, the UE 120 may be configured, preconfigured, hard-coded, or otherwise provided with multiple candidate RBRs, shown in example 445 as first RBR of 0 kilobits per second (kbit/s) through a 56^{th} RBR of 8000 kbit/s. Each candidate RBR may be associated with a respective codepoint or index, shown in example 445 as index 1 through index 56. In such examples, the network node 110 may signal (e.g., via an RBR MAC-CE or the congestion indication described above in connection with reference number 415) an RBR to the UE 120 by indicating an index associated with the selected RBR (which, as described above, may be an implicit indication of congestion in the shared resource pool 402, such as by signaling a high RBR to indicate low congestion or by signaling a low RBR to indicate high congestion). Moreover, in some aspects index 0 may be used to indicate that no new recommendation on bit rate is given, or indexes 57 through 63 may be reserved indexes or may not correspond to any RBR.

In some aspects, the candidate RBRs may be mapped to a backoff value, which, as described above, may be a scaling factor to be applied to a bit rate of an UL communication. For example, as shown in FIG. 4B, the candidate RBRs associated with indexes 1-14 (e.g., 0 kbit/s through 72 kbit/s) may be associated with a first backoff value, the candidate RBRs associated with indexes 15-31 (e.g., 88 kbit/s through 600 kbit/s) may be associated with a second backoff value, the candidate RBRs associated with indexes 32-41 (e.g., 700 kbit/s through 1750 kbit/s) may be associated with a third backoff value, or the candidate RBRs associated with indexes 42-56 (e.g., 2000 kbit/s through 8000 kbit/s) may be associated with a fourth backoff value, among other examples. In some other aspects, different sets of RBRs may be mapped to different backoff values without departing from the scope of the disclosure.

In some examples, the configuration information described above in connection with reference number 410 may indicate the various backoff values (e.g., backoff value 1 through backoff value 4 in example 445) or may indicate the mapping of the various backoff values to the indexes. For example, in some aspects, the mapping of the backoff values to the indexes may be preconfigured, hard-coded, or otherwise specified at the UE 120 (e.g., may be defined by a wireless communication specification, such as a specification promulgated by the 3GPP), and the specific backoff values (e.g., backoff values 1 through 4 in example 445) may be signaled to the UE 120 via the configuration information described above. In such aspects, and returning to the example 445, upon receipt of indications of the four specific backoff values in the configuration information, the UE 120 may identify (e.g., via an applicable wireless communication specification) that the first signaled backoff value should be used for RBR indexes 1-14, that the second signaled backoff value should be used for RBR indexes 15-31, that the third signaled backoff value should be used for RBR 32-41, or that the fourth signaled backoff value should be used for RBR indexes 42-56, among other examples. In such examples, upon receiving a signaled RBR from the network node 110 (e.g., via the congestion indication described above in connection with reference number 415 or an RBR MAC-CE, among other examples), the UE 120 may map the RBR to a corresponding backoff value or may transmit the UL communication using the shared resource pool 402 using the adjusted RBR (e.g., RBR adjusted by the scaling factor indicated by the mapped backoff value).

Although example 445 is described in terms of using an RBR as the congestion information, in some other aspects different types of congestion information may similarly be mapped to backoff values. For example, depending on the percentage of ECN-marked packets (e.g., indicated by a server end point) or an explicit congestion value (e.g., one of high, medium, low, or a congestion percentage value indicated by a congestion-specific MAC-CE, among other examples), the UE 120 may map the congestion information to a backoff value or may scale a bit rate to be used for the UL communication (e.g., an RBR indicated by the network node 110, among other examples) based at least in part on the determined backoff value.

Based at least in part on the UE 120 transmitting an UL communication by determining whether congestion information for the shared resource pool 402 satisfies a congestion threshold, or by mapping a backoff value to the congestion information for the shared resource pool 402, the UE 120 or the network node 110 may conserve computing, power, network, or communication resources that may have otherwise been consumed the UE 120 utilizing the shared resource pool 402 agnostic as to a congestion level thereof. For example, based at least in part on the UE 120 transmitting an UL communication by determining whether congestion information for the shared resource pool 402 satisfies a congestion threshold, or by mapping a backoff value to the congestion information for the shared resource pool 402, the UE 120 and the network node 110 may communicate with reduced UL collisions in the shared resource pool 402 and thus a reduced error rate, which may conserve computing, power, network, or communication resources that may have otherwise been consumed to detect or correct communication errors.

As indicated above, FIGS. 4A-4B are provided as an example. Other examples may differ from what is described with respect to FIGS. 4A-4B.

FIG. 5 is a diagram illustrating an example process 500 performed, for example, at a UE or an apparatus of a UE. Example process 500 is an example where the apparatus or the UE (e.g., UE 120) performs operations associated with congestion control of a shared resource pool.

As shown in FIG. 5, in some aspects, process 500 may include receiving configuration information indicating at least one of a congestion threshold associated with a shared resource pool, or one or more backoff values associated with the shared resource pool (block 510). For example, the UE (e.g., using reception component 702 or communication manager 706, depicted in FIG. 7) may receive configuration information indicating at least one of a congestion threshold associated with a shared resource pool, or one or more backoff values associated with the shared resource pool, as described above.

As further shown in FIG. 5, in some aspects, process 500 may include determining at least one of whether congestion information for the shared resource pool satisfies the congestion threshold, or a backoff value, of the one or more backoff values, associated with the congestion information (block 520). For example, the UE (e.g., using communication manager 706, depicted in FIG. 7) may determine at least one of whether congestion information for the shared resource pool satisfies the congestion threshold, or a backoff value, of the one or more backoff values, associated with the congestion information, as described above.

As further shown in FIG. 5, in some aspects, process 500 may include transmitting, based at least in part on the determination of the at least one of whether the congestion information satisfies the congestion threshold, or the backoff value associated with the congestion information, a communication (block 530). For example, the UE (e.g., using transmission component 704 or communication manager 706, depicted in FIG. 7) may transmit, based at least in part on the determination of the at least one of whether the congestion information satisfies the congestion threshold, or the backoff value associated with the congestion information, a communication, as described above.

Process 500 may include additional aspects, such as any single aspect or any combination of aspects described below or in connection with one or more other processes described elsewhere herein.

In a first aspect, process 500 includes receiving a congestion indication indicating the congestion information.

In a second aspect, alone or in combination with the first aspect, the congestion information is associated with an RBR per logical channel indicated by the congestion indication.

In a third aspect, alone or in combination with one or more of the first and second aspects, the congestion indication is a MAC-CE that indicates a congestion level associated with the shared resource pool.

In a fourth aspect, alone or in combination with one or more of the first through third aspects, the congestion information is associated with ECN-marked packets associated with the shared resource pool.

In a fifth aspect, alone or in combination with one or more of the first through fourth aspects, the congestion indication is received via at least one of AS signaling or IP layer marking.

In a sixth aspect, alone or in combination with one or more of the first through fifth aspects, the congestion threshold is associated with at least one of a bit rate associated with the shared resource pool, a congestion level associated with the resource pool, or a number of ECN-marked packets per time period associated with the shared resource pool.

In a seventh aspect, alone or in combination with one or more of the first through sixth aspects, the shared resource pool is associated with multiple logical channels, the configuration information further indicates another congestion threshold associated with the shared resource pool that differs from the congestion threshold, the congestion threshold is associated with a first logical channel, of the multiple logical channels, and the other congestion threshold is associated with a second logical channel, of the multiple logical channels.

In an eighth aspect, alone or in combination with one or more of the first through seventh aspects, process 500 includes performing one of transmitting the communication using the shared resource pool based at least in part on the congestion information not satisfying the congestion threshold, or transmitting a resource request associated with the communication based at least in part on the congestion information satisfying the congestion threshold.

In a ninth aspect, alone or in combination with one or more of the first through eighth aspects, transmitting the communication includes determining the backoff value associated with the communication.

In a tenth aspect, alone or in combination with one or more of the first through ninth aspects, determining the backoff value associated with the communication includes mapping the congestion information to a selected backoff value, of multiple candidate backoff values.

In an eleventh aspect, alone or in combination with one or more of the first through tenth aspects, process 500 includes receiving data to be transmitted that is associated with the shared resource pool, and transmitting a request for a congestion indication that indicates the congestion information based at least in part on receiving the data to be transmitted that is associated with the shared resource pool.

In a twelfth aspect, alone or in combination with one or more of the first through eleventh aspects, process 500 includes determining the congestion information based at least in part on data associated with the shared resource pool.

In a thirteenth aspect, alone or in combination with one or more of the first through twelfth aspects, process 500 includes transmitting capability information indicating a capability of the UE to determine the congestion information, wherein receiving the configuration information is based at least in part on transmitting the capability information.

In a fourteenth aspect, alone or in combination with one or more of the first through thirteenth aspects, determining the congestion information is based at least in part on a congestion model associated with the UE satisfying one or more KPI checks.

In a fifteenth aspect, alone or in combination with one or more of the first through fourteenth aspects, receiving the configuration information includes receiving the configuration information via at least one of an RRC release message or a SIB1 message.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node. Example process 600 is an example where the apparatus or the network node (e.g., network node 110) performs operations associated with congestion control of a shared resource pool.

As shown in FIG. 6, in some aspects, process 600 may include transmitting, to a UE, configuration information indicating at least one of a congestion threshold associated with a shared resource pool, or one or more backoff values associated with the shared resource pool (block 610). For example, the network node (e.g., using transmission component 804 or communication manager 806, depicted in FIG. 8) may transmit, to a UE, configuration information indicating at least one of a congestion threshold associated with a shared resource pool, or one or more backoff values associated with the shared resource pool, as described above.

As further shown in FIG. 6, in some aspects, process 600 may include receiving, from the UE, a communication, wherein at least one of: the communication is received using the shared resource pool based at least in part on congestion information associated with the shared resource pool not satisfying the congestion threshold, the communication is received using the shared resource pool and is associated with a backoff value, of the one or more backoff values, that is based at least in part on the congestion information, or the communication is received using resources outside of the shared resource pool based at least in part on the congestion information satisfying the congestion threshold (block 620). For example, the network node (e.g., using reception component 802 or communication manager 806, depicted in FIG. 8) may receive, from the UE, a communication, wherein at least one of: the communication is received using the shared resource pool based at least in part on congestion information associated with the shared resource pool not satisfying the congestion threshold, the communication is received using the shared resource pool and is associated with a backoff value, of the one or more backoff values, that is based at least in part on the congestion information, or the communication is received using resources outside of the shared resource pool based at least in part on the congestion information satisfying the congestion threshold, as described above.

Process 600 may include additional aspects, such as any single aspect or any combination of aspects described below or in connection with one or more other processes described elsewhere herein.

In a first aspect, process 600 includes transmitting, to the UE, a congestion indication indicating the congestion information.

In a second aspect, alone or in combination with the first aspect, the congestion information is associated with an RBR per logical channel indicated by the congestion indication.

In a third aspect, alone or in combination with one or more of the first and second aspects, the congestion indication is a MAC-CE that indicates a congestion level associated with the shared resource pool.

In a fourth aspect, alone or in combination with one or more of the first through third aspects, the congestion information is associated with ECN-marked packets associated with the shared resource pool.

In a fifth aspect, alone or in combination with one or more of the first through fourth aspects, the congestion indication is transmitted via at least one of AS signaling or IP layer marking.

In a sixth aspect, alone or in combination with one or more of the first through fifth aspects, the congestion threshold is associated with at least one of a bit rate associated with the shared resource pool, a congestion level associated with the resource pool, or a number of ECN-marked packets per time period associated with the shared resource pool.

In a seventh aspect, alone or in combination with one or more of the first through sixth aspects, the shared resource pool is associated with multiple logical channels, the configuration information further indicates another congestion threshold associated with the shared resource pool that differs from the congestion threshold, the congestion threshold is associated with a first logical channel, of the multiple logical channels, and the other congestion threshold is associated with a second logical channel, of the multiple logical channels.

In an eighth aspect, alone or in combination with one or more of the first through seventh aspects, process 600 includes receiving, from the UE, a resource request associated with the communication based at least in part on the congestion information satisfying the congestion threshold.

In a ninth aspect, alone or in combination with one or more of the first through eighth aspects, process 600 includes receiving, from the UE, a request for a congestion indication that indicates the congestion information.

In a tenth aspect, alone or in combination with one or more of the first through ninth aspects, process 600 includes receiving, from the UE, capability information indicating a capability of the UE to determine the congestion information, wherein transmitting the configuration information is based at least in part on receiving the capability information.

In an eleventh aspect, alone or in combination with one or more of the first through tenth aspects, transmitting the configuration information includes transmitting the configuration information via at least one of an RRC release message or a SIB1 message.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 4A-4B. Additionally, or alternatively, the apparatus 700 may be configured to perform one or more processes described herein, such as process 500 of FIG. 5. In some aspects, the apparatus 700 or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The reception component 702 may receive configuration information indicating at least one of a congestion threshold associated with a shared resource pool, or one or more backoff values associated with the shared resource pool. The communication manager 706 may determine at least one of whether congestion information for the shared resource pool satisfies the congestion threshold, or a backoff value, of the one or more backoff values, associated with the congestion information. The transmission component 704 may transmit, based at least in part on the determination of the at least one of whether the congestion information satisfies the congestion threshold, or the backoff value associated with the congestion information, a communication.

The reception component 702 may receive a congestion indication indicating the congestion information.

The communication manager 706 or the transmission component 704 may perform one of transmitting the communication using the shared resource pool based at least in part on the congestion information not satisfying the congestion threshold, or transmitting a resource request associated with the communication based at least in part on the congestion information satisfying the congestion threshold.

The reception component 702 or the communication manager 706 may receive data to be transmitted that is associated with the shared resource pool.

The transmission component 704 may transmit a request for a congestion indication that indicates the congestion information based at least in part on receiving the data to be transmitted that is associated with the shared resource pool.

The communication manager 706 may determine the congestion information based at least in part on data associated with the shared resource pool.

The transmission component 704 may transmit capability information indicating a capability of the UE to determine the congestion information wherein receiving the configuration information is based at least in part on transmitting the capability information.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network node, or a network node may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 4A-4B. Additionally, or alternatively, the apparatus 800 may be configured to perform one or more processes described herein, such as process 600 of FIG. 6. In some aspects, the apparatus 800 or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 or the transmission component 804 may include or may be included in a network interface. The network interface may be configured to obtain or output signals for the apparatus 800 via one or more communications links, such as a backhaul link, a midhaul link, or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The transmission component 804 may transmit, to a UE, configuration information indicating at least one of a congestion threshold associated with a shared resource pool, or one or more backoff values associated with the shared resource pool. The reception component 802 may receive, from the UE, a communication, wherein at least one of the communication is received using the shared resource pool based at least in part on congestion information associated with the shared resource pool not satisfying the congestion threshold, the communication is received using the shared resource pool and is associated with a backoff value, of the one or more backoff values, that is based at least in part on the congestion information, or the communication is received using resources outside of the shared resource pool based at least in part on the congestion information satisfying the congestion threshold.

The transmission component 804 may transmit, to the UE, a congestion indication indicating the congestion information.

The reception component 802 may receive, from the UE, a resource request associated with the communication based at least in part on the congestion information satisfying the congestion threshold.

The reception component 802 may receive, from the UE, a request for a congestion indication that indicates the congestion information.

The reception component 802 may receive, from the UE, capability information indicating a capability of the UE to determine the congestion information, wherein transmitting the configuration information is based at least in part on receiving the capability information.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:
Aspect 1: A method of wireless communication performed by a user equipment (UE), comprising: receiving configuration information indicating at least one of a congestion threshold associated with a shared resource pool, or one or more backoff values associated with the shared resource pool; determining at least one of whether congestion information for the shared resource pool satisfies the congestion threshold, or a backoff value, of the one or more backoff values, associated with the congestion information; and transmitting, based at least in part on the determination of the at least one of whether the congestion information satisfies the congestion threshold, or the backoff value associated with the congestion information, a communication.
Aspect 2: The method of Aspect 1, further comprising receiving a congestion indication indicating the congestion information.
Aspect 3: The method of Aspect 2, wherein the congestion information is associated with a recommended bit rate per logical channel indicated by the congestion indication.
Aspect 4: The method of Aspect 2, wherein the congestion indication is a medium access control (MAC) control element (MAC-CE) that indicates a congestion level associated with the shared resource pool.
Aspect 5: The method of Aspect 2, wherein the congestion information is associated with explicit-congestion-notification-marked packets associated with the shared resource pool.
Aspect 6: The method of Aspect 2, wherein the congestion indication is received via at least one of access stratum signaling or Internet protocol layer marking.
Aspect 7: The method of any of Aspects 1-6, wherein the congestion threshold is associated with at least one of: a bit rate associated with the shared resource pool, a congestion level associated with the resource pool, or a number of explicit-congestion-notification-marked packets per time period associated with the shared resource pool.
Aspect 8: The method of any of Aspects 1-7, wherein the shared resource pool is associated with multiple logical channels, wherein the configuration information further indicates another congestion threshold associated with the shared resource pool that differs from the congestion threshold, wherein the congestion threshold is associated with a first logical channel, of the multiple logical channels, and wherein the other congestion threshold is associated with a second logical channel, of the multiple logical channels.
Aspect 9: The method of any of Aspects 1-8, further comprising performing one of: transmitting the communication using the shared resource pool based at least in part on the congestion information not satisfying the congestion threshold, or transmitting a resource request associated with the communication based at least in part on the congestion information satisfying the congestion threshold.
Aspect 10: The method of any of Aspects 1-9, wherein transmitting the communication includes determining the backoff value associated with the communication.
Aspect 11: The method of Aspect 10, wherein determining the backoff value associated with the communication includes mapping the congestion information to a selected backoff value, of multiple candidate backoff values.
Aspect 12: The method of any of Aspects 1-11, further comprising: receiving data to be transmitted that is associated with the shared resource pool; and transmitting a request for a congestion indication that indicates the congestion information based at least in part on receiving the data to be transmitted that is associated with the shared resource pool.
Aspect 13: The method of any of Aspects 1-12, further comprising determining the congestion information based at least in part on data associated with the shared resource pool.
Aspect 14: The method of Aspect 13, further comprising transmitting capability information indicating a capability of the UE to determine the congestion information, wherein receiving the configuration information is based at least in part on transmitting the capability information.
Aspect 15: The method of Aspect 13, wherein determining the congestion information is based at least in part on a congestion model associated with the UE satisfying one or more key performance indicator checks.
Aspect 16: The method of any of Aspects 1-15, wherein receiving the configuration information includes receiving the configuration information via at least one of a radio resource control release message or a system information block 1 message.
Aspect 17: A method of wireless communication performed by a network node, comprising: transmitting, to a user equipment (UE), configuration information indicating at least one of a congestion threshold associated with a shared resource pool, or one or more backoff values associated with the shared resource pool; and receiving, from the UE, a communication, wherein at least one of: the communication is received using the shared resource pool based at least in part on congestion information associated with the shared resource pool not satisfying the congestion threshold, the communication is received using the shared resource pool and is associated with a backoff value, of the one or more backoff values, that is based at least in part on the congestion information, or the communication is received using resources outside of the shared resource pool based at least in part on the congestion information satisfying the congestion threshold.
Aspect 18: The method of Aspect 17, further comprising transmitting, to the UE, a congestion indication indicating the congestion information.
Aspect 19: The method of Aspect 18, wherein the congestion information is associated with a recommended bit rate per logical channel indicated by the congestion indication.
Aspect 20: The method of Aspect 18, wherein the congestion indication is a medium access control (MAC) control element (MAC-CE) that indicates a congestion level associated with the shared resource pool.
Aspect 21: The method of Aspect 18, wherein the congestion information is associated with explicit-congestion-notification-marked packets associated with the shared resource pool.
Aspect 22: The method of Aspect 18, wherein the congestion indication is transmitted via at least one of access stratum signaling or Internet protocol layer marking.
Aspect 23: The method of any of Aspects 17-22, wherein the congestion threshold is associated with at least one of: a bit rate associated with the shared resource pool, a congestion level associated with the resource pool, or a number of explicit-congestion-notification-marked packets per time period associated with the shared resource pool.
Aspect 24: The method of any of Aspects 17-23, wherein the shared resource pool is associated with multiple logical channels, wherein the configuration information further indicates another congestion threshold associated with the shared resource pool that differs from the congestion threshold, wherein the congestion threshold is associated with a first logical channel, of the multiple logical channels, and wherein the other congestion threshold is associated with a second logical channel, of the multiple logical channels.
Aspect 25: The method of any of Aspects 17-24, further comprising receiving, from the UE, a resource request associated with the communication based at least in part on the congestion information satisfying the congestion threshold.
Aspect 26: The method of any of Aspects 17-25, further comprising receiving, from the UE, a request for a congestion indication that indicates the congestion information.
Aspect 27: The method of any of Aspects 17-26, further comprising receiving, from the UE, capability information indicating a capability of the UE to determine the congestion information, wherein transmitting the configuration information is based at least in part on receiving the capability information.
Aspect 28: The method of any of Aspects 17-27, wherein transmitting the configuration information includes transmitting the configuration information via at least one of a radio resource control release message or a system information block 1 message.
Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-28.
Aspect 30: An apparatus for wireless communication at a device, the apparatus comprising one or more memories and one or more processors coupled to the one or more memories, the one or more processors configured to cause the device to perform the method of one or more of Aspects 1-28.
Aspect 31: An apparatus for wireless communication, the apparatus comprising at least one means for performing the method of one or more of Aspects 1-28.
Aspect 32: A non-transitory computer-readable medium storing code for wireless communication, the code comprising instructions executable by one or more processors to perform the method of one or more of Aspects 1-28.
Aspect 33: A non-transitory computer-readable medium storing a set of instructions for wireless communication, the set of instructions comprising one or more instructions that, when executed by one or more processors of a device, cause the device to perform the method of one or more of Aspects 1-28.
Aspect 34: A device for wireless communication, the device comprising a processing system that includes one or more processors and one or more memories coupled with the one or more processors, the processing system configured to cause the device to perform the method of one or more of Aspects 1-28.
Aspect 35: An apparatus for wireless communication at a device, the apparatus comprising one or more memories and one or more processors coupled to the one or more memories, the one or more processors individually or collectively configured to cause the device to perform the method of one or more of Aspects 1-28.
Aspect 36: A device comprising a processing system that includes one or more processors and one or more code-storing memories coupled with the one or more processors, the processing system configured to cause the device to perform the method of one or more of Aspects 1-28.
Aspect 37: A device comprising a processing system that includes processor circuitry and code-storing memory circuitry, the processing system configured to cause the device to perform the method of one or more of Aspects 1-28.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples.

In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive configuration information indicating at least one of a congestion threshold associated with a shared resource pool, or one or more backoff values associated with the shared resource pool;
determine at least one of whether congestion information for the shared resource pool satisfies the congestion threshold, or a backoff value, of the one or more backoff values, associated with the congestion information; and
transmit, based at least in part on the determination of the at least one of whether the congestion information satisfies the congestion threshold, or the backoff value associated with the congestion information, a communication.

2. The UE of claim 1, wherein the processing system is configured to cause the UE to receive a congestion indication indicating the congestion information.

3. The UE of claim 2, wherein the congestion information is associated with a recommended bit rate per logical channel indicated by the congestion indication.

4. The UE of claim 2, wherein the congestion indication is a medium access control (MAC) control element (MAC-CE) that indicates a congestion level associated with the shared resource pool.

5. The UE of claim 2, wherein the congestion information is associated with explicit-congestion-notification-marked packets associated with the shared resource pool.

6. The UE of claim 2, wherein the processing system, to cause the UE to receive the congestion indication, is configured to cause the UE to receive the congestion indication via at least one of access stratum signaling or Internet protocol layer marking.

7. The UE of claim 1, wherein the congestion threshold is associated with at least one of:
a bit rate associated with the shared resource pool,
a congestion level associated with the resource pool, or
a number of explicit-congestion-notification-marked packets per time period associated with the shared resource pool.

8. The UE of claim 1, wherein the shared resource pool is associated with multiple logical channels,
wherein the configuration information further indicates another congestion threshold associated with the shared resource pool that differs from the congestion threshold,
wherein the congestion threshold is associated with a first logical channel, of the multiple logical channels, and
wherein the other congestion threshold is associated with a second logical channel, of the multiple logical channels.

9. The UE of claim 1, wherein the processing system is configured to cause the UE to perform one of:
transmit the communication using the shared resource pool based at least in part on the congestion information not satisfying the congestion threshold, or
transmit a resource request associated with the communication based at least in part on the congestion information satisfying the congestion threshold.

10. The UE of claim 1, wherein the processing system, to cause the UE to transmit the communication, is configured to cause the UE to determine the backoff value associated with the communication.

11. The UE of claim 10, wherein the processing system, to cause the UE to determine the backoff value associated with the communication, is configured to cause the UE to map the congestion information to a selected backoff value, of multiple candidate backoff values.

12. The UE of claim 1, wherein the processing system is configured to cause the UE to: receive data to be transmitted that is associated with the shared resource pool; and
transmit a request for a congestion indication that indicates the congestion information based at least in part on receiving the data to be transmitted that is associated with the shared resource pool.

13. The UE of claim 1, wherein the processing system is configured to cause the UE to determine the congestion information based at least in part on data associated with the shared resource pool.

14. The UE of claim 13, wherein the processing system is configured to cause the UE to transmit capability information indicating a capability of the UE to determine the congestion information, and
wherein the processing system, to cause the UE to receive the configuration information, is configured to cause the UE to receive the configuration information based at least in part on transmitting the capability information.

15. The UE of claim 13, wherein the processing system, to determine the congestion information, is configured to cause to the UE to determine the congestion information based at least in part on a congestion model associated with the UE satisfying one or more key performance indicator checks.

16. The UE of claim 1, wherein the processing system, to cause the UE to receive the configuration information, is configured to cause the UE to receive the configuration information via at least one of a radio resource control release message or a system information block 1 message.

17. A network node, comprising:
a processing system that includes one or more processors and one or more code-storing memories coupled with the one or more processors, the processing system configured to cause the network node to:
transmit, to a user equipment (UE), configuration information indicating at least one of a congestion threshold associated with a shared resource pool, or one or more backoff values associated with the shared resource pool; and
receive, from the UE, a communication, wherein the processing system, to receive the communication, is configured to cause the network node to at least one of:
receive the communication using the shared resource pool based at least in part on congestion information associated with the shared resource pool not satisfying the congestion threshold,
receive the communication using the shared resource pool, wherein the communication is associated with a backoff value, of the one or more backoff values, that is based at least in part on the congestion information, or
receive the communication using resources outside of the shared resource pool based at least in part on the congestion information satisfying the congestion threshold.

18. The network node of claim 17, wherein the processing system is configured to cause the network node to transmit, to the UE, a congestion indication indicating the congestion information.

19. The network node of claim 18, wherein the congestion information is associated with a recommended bit rate per logical channel indicated by the congestion indication.

20. The network node of claim 18, wherein the congestion indication is a medium access control (MAC) control element (MAC-CE) that indicates a congestion level associated with the shared resource pool.

21. The network node of claim 18, wherein the congestion information is associated with explicit-congestion-notification-marked packets associated with the shared resource pool.

22. The network node of claim 18, wherein the congestion indication is transmitted via at least one of access stratum signaling or Internet protocol layer marking.

23. The network node of claim 17, wherein the congestion threshold is associated with at least one of:
a bit rate associated with the shared resource pool,
a congestion level associated with the resource pool, or
a number of explicit-congestion-notification-marked packets per time period associated with the shared resource pool.

24. The network node of claim 17, wherein the shared resource pool is associated with multiple logical channels,
wherein the configuration information further indicates another congestion threshold associated with the shared resource pool that differs from the congestion threshold,
wherein the congestion threshold is associated with a first logical channel, of the multiple logical channels, and
wherein the other congestion threshold is associated with a second logical channel, of the multiple logical channels.

25. The network node of claim 17, wherein the processing system is configured to cause the network node to receive, from the UE, a resource request associated with the communication based at least in part on the congestion information satisfying the congestion threshold.

26. The network node of claim 17, wherein the processing system is configured to cause the network node to receive, from the UE, a request for a congestion indication that indicates the congestion information.

27. The network node of claim 17, wherein the processing system is configured to cause the network node to receive, from the UE, capability information indicating a capability of the UE to determine the congestion information,
wherein the processing system, to transmit the configuration information, is configured to cause the network node to transmit the configuration information based at least in part on receiving the capability information.

28. The network node of claim 17, wherein the processing system, to cause the network node to transmit the configuration information, is configured to cause the network node to transmit the configuration information via at least one of a radio resource control release message or a system information block 1 message.

29. A method of wireless communication performed by a user equipment (UE), comprising: receiving configuration information indicating at least one of a congestion threshold associated with a shared resource pool, or one or more backoff values associated with the shared resource pool;
determining at least one of whether congestion information for the shared resource pool satisfies the congestion threshold, or a backoff value, of the one or more backoff values, associated with the congestion information; and
transmitting, based at least in part on the determination of the at least one of whether the congestion information satisfies the congestion threshold, or the backoff value associated with the congestion information, a communication.

30. A method of wireless communication performed by a network node, comprising:
transmitting, to a user equipment (UE), configuration information indicating at least one of a congestion threshold associated with a shared resource pool, or one or more backoff values associated with the shared resource pool; and
receiving, from the UE, a communication, wherein at least one of:
the communication is received using the shared resource pool based at least in part on congestion information associated with the shared resource pool not satisfying the congestion threshold,
the communication is received using the shared resource pool and is associated with a backoff value, of the one or more backoff values, that is based at least in part on the congestion information, or
the communication is received using resources outside of the shared resource pool based at least in part on the congestion information satisfying the congestion threshold.
